(19) United States
(12) Patent Application Publication
(10) Pub. No.: US 2016/0345045 A1
(43) Pub. Date: Nov. 24, 2016

(54) VEHICLE DISPLAY SYSTEM

(71) Applicants: Calvin Liu, City of Industry, CA (US); Willie Liu, City of Industry, CA (US)

(72) Inventors: Calvin Liu, City of Industry, CA (US); Willie Liu, City of Industry, CA (US)

(21) Appl. No.: 15/227,607

(22) Filed: Aug. 3, 2016

Related U.S. Application Data
(63) Continuation-in-part of application No. 14/262,541, filed on Apr. 25, 2014, now Pat. No. 9,432,716.
Application No. 14/262,541 is a continuation-in-part of application No. 12/924,949, filed on Oct. 8, 2010, now Pat. No. 8,740,301.

(51) Int. Cl. H04N 21/414; B60R 1/00; B60K 37/04; G06F 1/16

(52) U.S. Cl. CPC H04N 21/41422; G06F 1/1633; B60R 1/00; B60K 37/04; B60K 2350/106; B60R 2300/207

(57) ABSTRACT

A vehicle display system. The system may comprise a display device; a frame; a connector plate; and a universal display adaptor. The display device may comprise: a display screen, a housing, a rear casing, a circuit board, and wire harness. The connector plate and rear casing may have openings, such that the wire harness may pass from the circuit board to the universal display adaptor. The frame and the display device are removeably mounted onto a front face of the connector plate. The universal display adaptor is mounted onto a back face of the connector plate. The aftermarket vehicle display system may be configured to be mounted into an interior of any late model vehicle.

### CROSS-REFERENCE TO RELATED APPLICATIONS

This application claims the benefit of Continuation-In-Part patent application Ser. No. 14/262,541, filed on Apr. 25, 2014, titled “In-Vehicle Display For Audio-Video Distribution”, by inventor Calvin Liu, the contents of which are expressly incorporated herein by this referenced as though set forth in their entirety and to which priority is claimed. Continuation-In-Part patent application Ser. No. 14/262,541 claims the benefit of U.S. Non-Provisional patent application Ser. No. 12/924,949, filed on Oct. 8, 2010, titled “Vehicle Seat Headrest With Built-In Communication Tool”, by inventor Calvin Liu.

### FIELD OF USE

The present disclosure relates generally to display systems, and more specifically, to aftermarket display devices and systems that are installed in the dashboard of a vehicle.

### BACKGROUND

With the rapid development of urban and inter-urban roads, the use of navigation systems to guide the route has become widespread. Although many vehicles may be sold with navigation systems as a standard feature, navigation systems are still mostly an upgrade. Additionally many vehicles sold, including many used cars, do not even provide the option of upgrading to include a navigation system.

Due to the usefulness of navigation systems, many consumers are having navigation systems mounted to the top exterior of their dashboard. Due to the placement of these navigation systems, these systems are distracting, hard to use, hard to power, and generally unattractive. As a solution to this, some companies have started offering aftermarket navigation systems that are sold as kits to be installed in very specific vehicles. But these systems are expensive because they only fit a few types of vehicles, which requires manufacturers to make dozens, if not hundreds of different types of interface modules.

Therefore, there exists a need for aftermarket display devices that may be configured to work with any vehicle. There is also a need for the universal display adaptor and universal display device, to be able to function as a standalone navigation system or to be able to communicate with and be controlled by an external electronic device.

### SUMMARY OF ILLUSTRATIVE EMBODIMENTS

To minimize the limitations in the cited references, and to minimize other limitations that will become apparent upon reading and understanding the present specification, the present specification discloses new and improved aftermarket dashboard mounted display systems.

One embodiment may be vehicle display system comprising: a display device; a frame;

a connector plate; and a universal display adaptor. The display device may comprise: a display screen, a housing, a rear casing, an electronic computing unit, and a wire harness. The connector plate may comprise a connector plate opening. The rear casing may comprise a rear casing opening. The wire harness may comprise an adaptor connector. The wire harness may be coupled to the electronic computing unit and pass through the connector plate opening and the rear casing opening, and the adaptor connector may couple to the universal display adaptor. The frame and the display device may be mounted onto a front face of the connector plate. The universal display adaptor may be mounted onto a back face of the connector plate; and the vehicle display system may be configured to be installed into an interior of a vehicle. The system is preferably installed into a dashboard of the interior of a vehicle. The electronic computing unit may communicate with and/or be controlled by one or more external electronic devices. The display screen may mirror a display of the one or more external electronic devices. The electronic computing unit may comprise a navigation system. The universal display adaptor may have a plurality of vehicle connection ports, which may be modular and interchangeable to allow the vehicle display system to universally interconnect with substantially all late model vehicles. The one or more of the plurality of vehicle connector ports may couple with an OEM harness of the vehicle. There may be four or more vehicle connection ports.

Another embodiment may be a universal vehicle display system, comprising: a display device; and a universal display adaptor; wherein the display device may comprise: a display screen, an electronic computing unit, and a wire harness. The wire harness may comprises an adaptor connector, wherein the wire harness may be coupled to the electronic computing unit and the adaptor connector may couple with the universal display adaptor. The vehicle display system may be configured to be installed into an interior of a vehicle. The universal display adaptor may have a plurality of vehicle connection ports; wherein one or more of the plurality of vehicle connector ports may be adapted to couple with an OEM harness of the vehicle. The plurality of vehicle connection ports may be modular and interchangeable to allow the vehicle display system to universally interconnect with substantially all late model vehicles. The vehicle display system may be configured to be installed into a dashboard of the interior of a vehicle. The electronic computing unit may communicate with and/or be controlled by one or more external electronic devices. The display screen may mirror a display of the one or more external electronic devices. The electronic computing unit may comprise a navigation system. There may be four or more vehicle connection ports.

Another embodiment may be a vehicle display system, comprising: a display device; a universal display adaptor; wherein the display device may comprise: a display screen, an electronic computing unit, and a wire harness, which may comprise an adaptor connector. The wire harness may be coupled to the electronic computing unit and the adaptor connector may couple to the universal display adaptor. The vehicle display system may be configured to be installed into a dashboard of a vehicle. The electronic computing unit may communicate with and/or be controlled by one or more external electronic devices. The display screen may mirror a display of the one or more external electronic devices. The electronic computing unit may comprise a navigation system. The universal display adaptor may have a plurality of vehicle connection ports. The plurality of vehicle connection ports may be modular and interchangeable to allow the vehicle display system to universally interconnect with substantially all late model vehicles. The one or more of the plurality of vehicle connector ports may couple with an OEM harness of the vehicle.

It is an object to provide an in-vehicle display system that utilizes a universal display adaptor and universal display device that may be adaptable for any make or model of a vehicle.

The display system may comprise a display device and a host unit, which are connected via an intermediate connector plate. The host unit may be fixed to the back of the connector plate. The connector plate may have connection posts that may be attached to and detached from the display device. The connector plate may have a connector plate opening. The data lines from the display device may pass through the opening and connect to the host unit. This configuration preferably allows the navigation display and system to be mounted into almost any vehicle. This has the added benefit of significantly reducing production costs.

In one embodiment the system may be an aftermarket display device that is installed in the dashboard of a vehicle. The display device may be programmed with a navigation system and may include a mirroring function (i.e., Miracast®) that mirrors a display of an independent electronic device such as smartphone, tablet, or desktop computer screen to the vehicle's display unit without the use of physical cables. In this embodiment, the user may display a navigation App, such as Waze®, on the display screen, just as it appear on the phone or tablet that is running the App. When parked, the display screen may display entertainment being displayed on the mirrored computing device.

It is an object to overcome the limitations of the prior art.

Other features and advantages inherent in the vehicle display system, as claimed and disclosed will become apparent to those skilled in the art from the following detailed description and its accompanying drawings.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is a schematic flow diagram of one embodiment of the vehicle display system.

FIG. 2 is an illustration of one embodiment of an exploded front perspective view of the vehicle display device.

FIG. 3 is an illustration of one embodiment of an exploded front perspective view of the vehicle display system.

FIG. 4 is an illustration of one embodiment of a front perspective view of the vehicle display system.

FIG. 5 is an illustration of one embodiment of a rear perspective view of the vehicle display system.

### DETAILED DESCRIPTION OF THE DRAWINGS

In the following detailed description, numerous specific details are set forth in order to provide a thorough understanding of various aspects of the embodiments of the vehicle display devices and systems. However, these embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of these embodiments. For purposes of this specification, unless otherwise specified, the term “substantially” refers to the complete or nearly complete extent or degree of an action, characteristic, property, state, structure, item, or result. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

As used herein, the term “external electronic device”, “computing device”, “computer”, “mobile electronic device” generally refers to any device with wireless capabilities, including without limitation, cellular phones, tablet computers, personal digital assistants, digital media players, portable game players, and hand-held computers.

As used herein, the term “Internet” may refer to any collection of networks that utilizes standard protocols, whether Ethernet, Token ring, Wifi®, WiMax® asynchronous transfer mode (ATM), Fiber Distributed Data Interface (FDDI), code division multiple access (CDMA), global systems for mobile communications (GSM), long term evolution (LTE), or any combination thereof.

As used herein, the terms “display” and “display screen” generally refer to any electronic output device for the visual presentation of digital content. The displays disclosed herein may utilize various screen technologies, including without limitation, liquid crystal display (LCD), light emitting diode (LED), thin-film transistor (TFT), and the like.

As used herein, the terms “application”, “software”, and “software application” generally refer to any set of machine-readable instructions on a client machine, web interface, and/or computer downloadable or externally hosted, which directs a computer's processor to perform specific steps, processes, or operations disclosed herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de factor equivalent of any other member of the same list solely based on its presentation in a common group without indications to the contrary.

As used herein, the term “connection module” generally refers to any hardware or executable code that performs one or more functions that allows an electronic device to exchange data or connect to the vehicle display system disclosed herein or the Internet by utilizing one or more technologies, including without limitation, wireless local area network module (e.g., WiFi® technology), wireless personal area network module (e.g., Bluetooth® technology), broadband wireless access module (e.g., WiMax® technology), echo display module (e.g., Miracast® technology), and the like. The connection between the electronic device and the vehicle display system (or Internet) may be performed wirelessly or via physical connection.

It should also be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or multiple instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

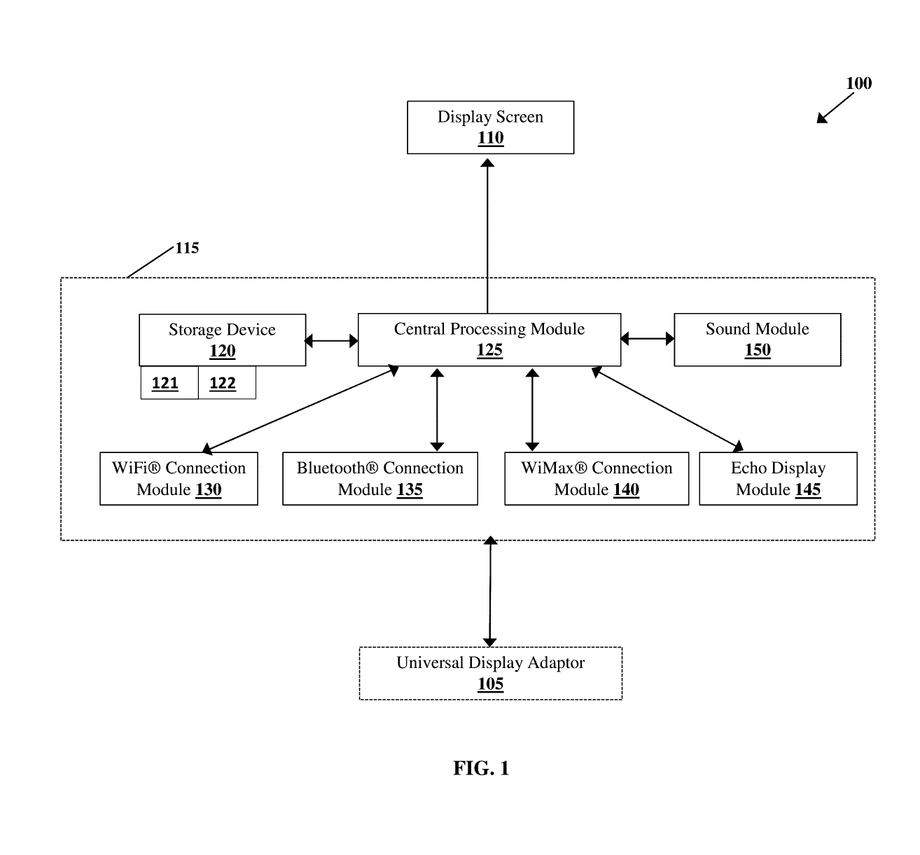

FIG. 1 is a schematic flow diagram of one embodiment of the vehicle display system. One embodiment of the aftermarket vehicle display system 100 may comprise: a display device, a decorative frame, a connector plate, and a universal display adaptor 105. The universal display adaptor 105 may be adapted to electrically couple to the display screen 110. The universal display adaptor 105 may communicate with the display screen 110 through a circuit board and/or one or more wire connectors. The circuit board and/or one or more wire connectors may allow bi-directional transmission of data between the universal display adaptor 105 and the display screen 110. Preferably, the universal display adaptor 105 is available in a single standard size, but may be any shape or size. The universal display adaptor 105 may be mounted to the mounting arrangement in the interior of a vehicle, enabling the installation of the universal display adaptor 105 and the display device into any make or model of a vehicle. Preferably, the mounting arrangement may be located on the dashboard or upper center console of a vehicle. The mounting arrangement may comprise a receiving cavity configured to house the universal display adaptor 105. The universal display adaptor 105 may be readily installed and removed from the interior of a vehicle.

Although the display system disclosed herein is primarily a display system that allows the user to view a map display and navigation system to assist with addresses and directions, the system may also interconnect for purposes of upgrades and/or media presentations. The display device may comprise: display screen 110, a frame, a circuit board, one or more wire connectors, a rear casing, an electronic computing unit 115, one or more connection modules 125, 130, 135, 140, 145, 150, a storage device 120, and a control panel.

The electronic computing unit 115 may include programming for a navigation system 121 and/or a radio control system 122 that may be accessed by the central processing module 125. The navigation system 121 and/or radio control system 122 may also be displayed, accessed, and/or controlled on the display screen 110. In some embodiments, the navigation system 121 and radio control system 122 may be modules and/or stored on the storage device 120. Map data derived by the navigation system 121 may also be stored in the storage device 120. For example, in one embodiment, the navigation system 121 may be stored in the electronic computing unit 115 while the map data may be stored in the storage device 120.

The system 100 may also comprise a radio control module and/or a climate control module, such that if any radio controls or climate controls are removed to create space, the user can simply use the display screen 110 to control the radio and/or climate within the vehicle.

The display screen 110 may be any electronic output device for the visual presentation of digital content and may utilize various screen technologies such as liquid crystal display (LCD), light emitting diode (LED), thin-film transistor (TFT), and the like. The display screen 110 may also be a touch screen with touch sensitive controls and may further comprise an LED backlit panel for exceptional picture quality, high efficiency, and long life. The display screen 110 may be housed with a frame, and the frame may be manufactured from any material including, but not limited to, metal and decorative wood. The frame may be removeably coupled to the rear casing such that the display screen 110 may be positioned adjacent the rear casing. The display screen 110 may be electrically coupled to the universal display adaptor 105,315 via a circuit board and/or one or more wire connectors.

In addition, the electronic computing unit 115 may be electrically coupled with the display screen 110, and may be configured to wirelessly communicate with external electronic devices such that the electronic computing unit 115 may wirelessly link the display screen 110 with one or more external electronic devices.

The electronic computing unit 115 may comprise one or more modules such as: a central processing module 125, a wireless local area network module 130, a wireless personal area network module 135, a broadband wireless access module 140, an echo display module 145, and a sound module 150. The electronic computing unit 115 may be a circuit board and related electronic components, including communication tools and components, which allow the display device system to communicate with and/or be controlled by external electronic computing devices such as smartphones, tablets, and computers.

The central processing module 125 may be electrically coupled to and/or part of the electronic computing unit 115 and storage device 120 to control and coordinate the operation of the systems and modules. The central processing module 125 may be further configured to interact with the wireless local area network module 130, wireless personal area network module 135, broadband wireless access module 140, echo display module 145, or sound module 150.

The wireless local area network module 130 and broadband wireless access module 140 may be configured to wirelessly connect the display device to the Internet, such that a user is able to access the Internet through the display screen 110. A preferred embodiment of the wireless local area network module 130 may utilize WiFi® technology to allow the display screen 110 to exchange data or connect to the Internet wirelessly generally using 2.4 GHz UHF waves and 5 GHz SHF waves. When the display system is wirelessly connected to the Internet through the wireless local area network module 130 or broadband wireless access module 140, the user and/or the system may access the Internet via the display screen 110. An embodiment of the broadband wireless access module 140 may be WiMax® technology, which is generally a wireless protocol designed to provide high speed Internet with transfer data rates of over 100 megabit-per-second.

The wireless personal area network module 135 may be configured to wirelessly connect an external electronic device to the display screen 110, such that the user is able to exchange data between the external electronic device and the display screen 110 within a short distance. An embodiment of the wireless personal area network module 135 may utilize Bluetooth® wireless technology in order to exchange data over short distances (using short-wavelength UHF radio waves in the ISM band from 2.4 to 2.485 GHz) from fixed and mobile devices.

The echo display module 145 may be configured to mirror or echo the digital content displayed on the external electronic device of the user to the display screen 110. An embodiment of the echo display module 145 may utilize Miracast® technology, which is generally a peer-to-peer wireless screen casting standard formed via Wi-Fi Direct® connections in a manner similar to Bluetooth®. The echo display module 145, such as Miracast®, generally enables wireless delivery of audio and video to or from desktops, tablets, mobile phones, and other devices. Importantly, several vehicle display systems may be used, such that a single external electronic device may be able to provide presentation material to multiple display screens in the vehicle. A user, for example, may be able to publish information stored in his or her laptop computer to many different people while traveling.

The electronic computing unit 115 may further comprise at least one connection port, such as a universal serial bus (USB) connection port, provided on the display screen 110 for allowing the electronic computing unit 115 to communicate with an external electronic device. Thus, a user may connect his or her own external electronic device to the display screen 110 through the connection port and a wire connector so as to allow the display screen 110 to play media content contained in the external electronic device.

The sound module 150 may be configured to generate audible sound and may utilize automatic loudness control (ALC) technology to address typical loudness problems, including audio jumps between programs and commercials, without adversely impacting the program content. The sound module 150 may also comprise of transmitters (e.g., FM transmitters).

The display screen 110 may also comprise other components such as 3.5 mm audio jacks for headphones, A/V inputs (e.g., RCA input), wireless remote controls, and an infrared (IR) transmitter (e.g., Channel A: approximately 2.3 MHz (left) to 2.8 MHz (right); Channel B: approximately 3.2 MHz (left) to 3.8 MHz (right)).

The display device 205 may further comprise a storage device 120. The storage device 120 may generally be any device for storing digital or multi-media content and data. Preferably, the storage device 120 may store a predetermined amount of video, navigation system, climate controls, game, photo, and/or music files. The media content may then be displayed on the display screen 225.

In order to facilitate control and interaction of the display screen 110 and external electronic device, the display screen 110 may further comprise a control panel electrically connected with the central processing module 125 for control of the various components mentioned above and to provide a platform for allowing the user to interact with the external electronic device. The control panel may be a physical control panel separately extended or part of the display device. On the other hand, the control panel may be incorporated into the LCD panel of the display screen 110 as soft keys so that the touch-screen feature of the LCD panel may be used by the user for making inputting commands to control the display system or the external electronic device. Alternatively, the user may control the operation of the external electronic device through its own control panel.

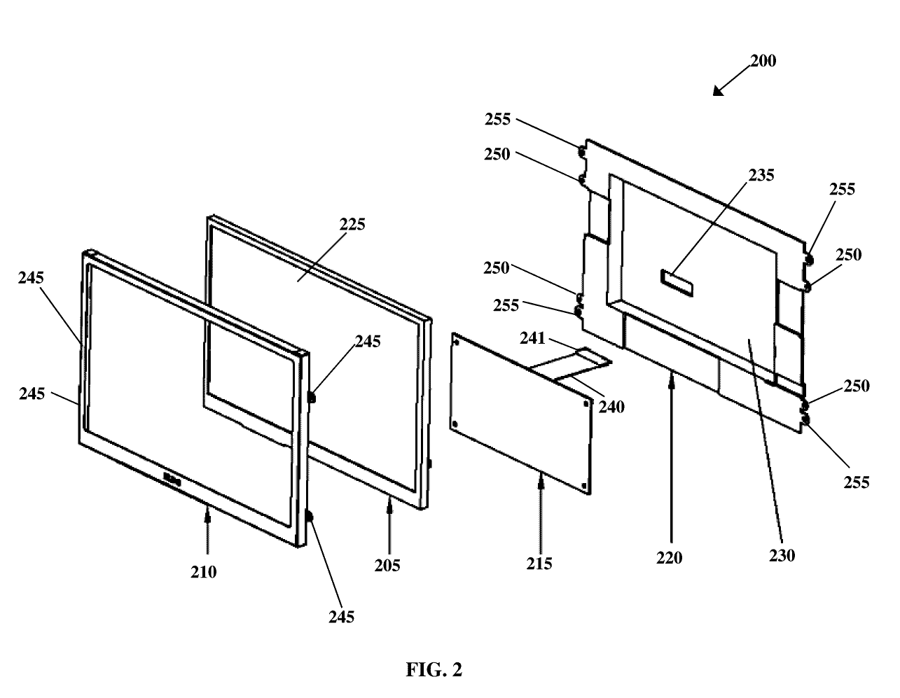

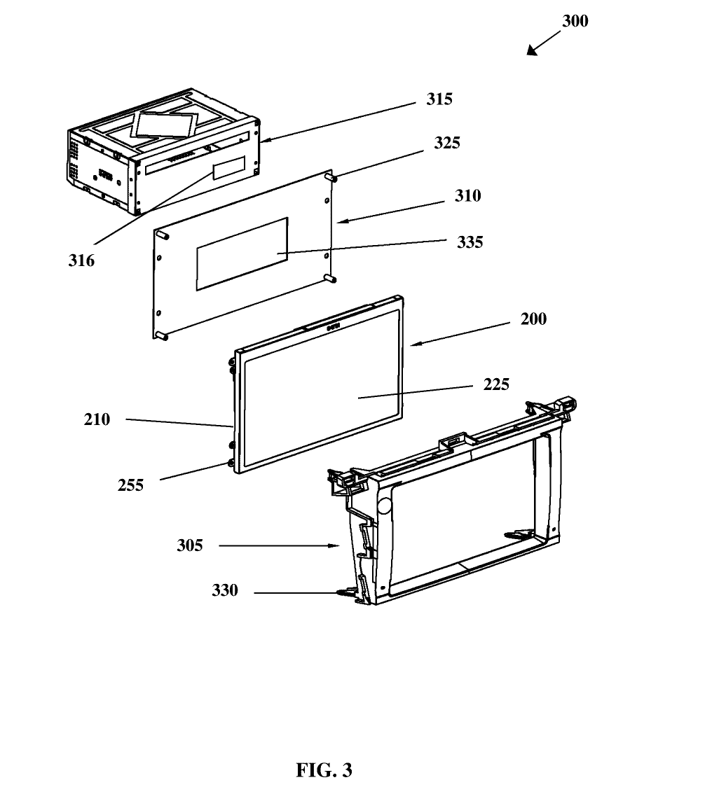

FIG. 2 is an illustration of one embodiment of an exploded front perspective view of the vehicle display device. As shown in FIG. 2, one embodiment of the display device 200 may comprise: a display screen 205, a housing 210, a circuit board 215, wire harness 240, adapter connector 241, a rear casing 220, and as shown in FIG. 1, an electronic computing unit, one or more connection modules, a storage device, and a control panel. The display screen 205 may be any electronic output device for the visual presentation of digital content, including navigation and directions content, and may utilize various screen technologies such as liquid crystal display (LCD) 225. The display screen 205 may also be a touch screen with touch sensitive controls such that a user may make input commands to control the display screen 205 or an external electronic device. The display screen 205 may be housed within a housing 210. The housing 210 may be removeably coupled to the rear casing 220 such that the display screen 205 may be positioned on a front portion of the rear casing 220. Preferably, the housing 210 may have housing brackets 245 that are configured to match up with rear casing brackets 250 of the rear casing 220 in order to couple the housing 210 and the rear casing 220 together, thereby securing the display screen 205 and circuit board 215 between the two portions. The rear casing 220 may comprise a cavity 230 and the cavity 230 may comprise an opening or window 235. The rear casing opening 235 within the cavity 230 of the rear casing 220 may be configured to receive and let pass the wire harness 240 from the circuit board 215 in order to establish an electrical connection between the display screen 205 and the universal display adaptor 315 (shown in FIGS. 3-5). The wire harness 240 preferably comprises an adapter connector 241 that is configured to matingly engage with a connection port 316 (shown in FIG. 3).

The display screen 205 may be configured to communicate with a universal display adaptor 315 via a circuit board 215 and wire harness 240. Specifically, the circuit board 215 may connect to or be positioned on a rear portion of the display screen 205, and when the housing 210 and the rear casing 220 are coupled together, the circuit board 215 may provide an electrical connection between the display screen 205 and the universal display adaptor 315. FIG. 2 also shows how the display device 200 may have display brackets 255, which are configured to allow the display device 200 to be removeably attached to connector plate 310.

In another embodiment, the display device 200 may further comprise an electronic computing unit, one or more connection modules, a storage device, and a control panel, as shown in FIG. 1. In that embodiment, the one or more connection modules housed within the electronic computing unit may comprise: a central processing module, a wireless local area network module, a wireless personal area network module, a broadband wireless access module, an echo display module, and a sound module. The electronic computing unit, amongst many other features, may be electrically coupled to the display screen 205 and permit communication between the display screen 205 and the universal display adaptor 315. Moreover, the display device may further comprise a central processing module, which may be electrically coupled to the electronic computing unit and storage device to control and coordinate the operation of each of these components. In addition, in order to facilitate control and interaction between the display screen 205 and an external electronic device, a control panel may be electrically connected with the central processing module for control of the various components mentioned above and to provide a platform for allowing the user to interact with the external electronic device. The display device 200 may further comprise a storage device, which may have a predetermined amount of storage capacity for storing multimedia materials. The circuit board 215 may be or may be part of the computing unit 115.

FIG. 3 is an illustration of one embodiment of an exploded front perspective view of the vehicle display system. As shown in FIG. 3, one embodiment of the display system 300 may comprise: a display device 200; a decorative frame 305; a connector plate 310; a universal display adaptor 315; and a mounting arrangement. As shown in FIGS. 1 and 2, an embodiment of the the display device 200 may comprise: a display screen 225, a housing 210, a circuit board, one or more wire connectors, a rear casing, an electronic computing unit, one or more connection modules, a storage device, and a control panel.

The display screen 205 may be housed within a housing 210. The housing 210 may be removeably coupled to a rear casing 220. The housing 210 and the rear casing 220 may further comprise one or more display brackets 255. The brackets 255 may be attached to and project outward from the display device 200, such that when the housing 210 and the rear casing are coupled together, one or more connector posts 325 of the connector plate 310 may pass through, couple with, or otherwise engage to the brackets 255. The one or more connector posts 325 may also be adapted to connect to one or more female-threaded connectors of the decorative frame 305 such that the connector posts 325 may be substantially frictionally fitted and held within the female connectors or plugs 330. The connector posts 325 of the connector plate 310 may protrude from the frontside of the connector plate 310, whereas, plugs 330 of the decorative frame 305 may protrude from or be located at a rearside of the decorative frame 305. In other embodiments, the system may be interconnected with additional parts, such as screws.

When the connector plate 310, display device 200, and decorative frame 305 are coupled together, the decorative frame 305 may substantially house the display device 200. A user may remove the decorative frame 305 by firmly pulling or twisting the decorative frame 305 away from the connector plate 310 and display device 200. The decorative frame 305 may be attractive and/or aesthetically pleasing.

The connector plate 310 may further comprise connector plate opening 335. When the connector plate 310 is coupled to decorative frame 305, the connector plate opening 335 of the connector plate 310 may align with the rear casing opening 235 of the cavity 230 of the rear casing 220 and further receive the wire harness 240 of the circuit board passing through the rear casing opening 235 of the cavity 230 of the rear casing 220. Accordingly, the wire harness 240 of the circuit board may pass through both openings 235, 335 and provide an electrical connection between the universal display adaptor 315 and the display screen 225.

FIG. 3 shows how the adapter connector 241 is configured to couple with connection port 316 of the universal display adaptor 315. The universal display adaptor 315 may allow various sizes of display devices 200 to be configured to connect to the universal display adaptor.

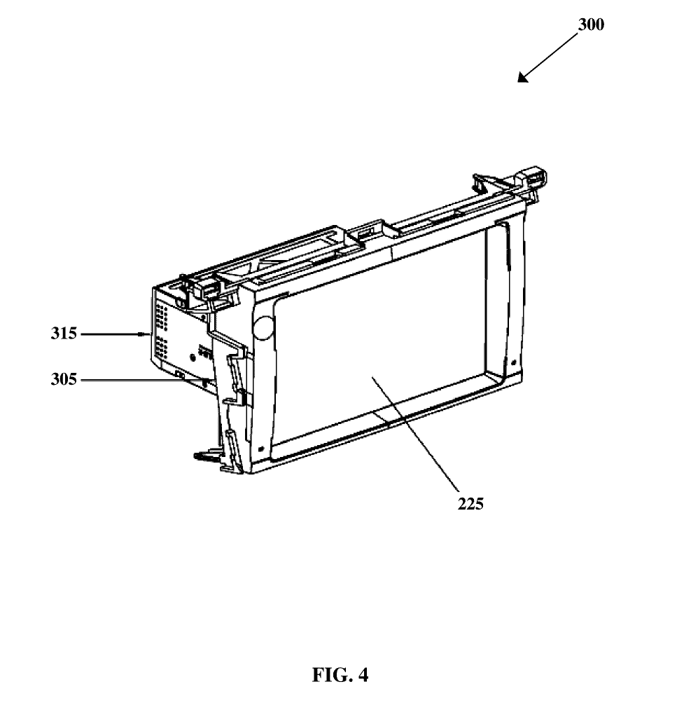

FIG. 4 is an illustration of one embodiment of a front perspective view of the vehicle display system. FIG. 4 shows how the system 300 may preferably be coupled together, such that the display screen 225 may be substantially housed within a decorative frame 305 and connected to universal display adaptor 315. Once coupled together, the system 300 is ready to be installed into a dashboard of a vehicle. In some embodiments the frame may be configured to have vent holes such that it fits over and does not block existing vents.

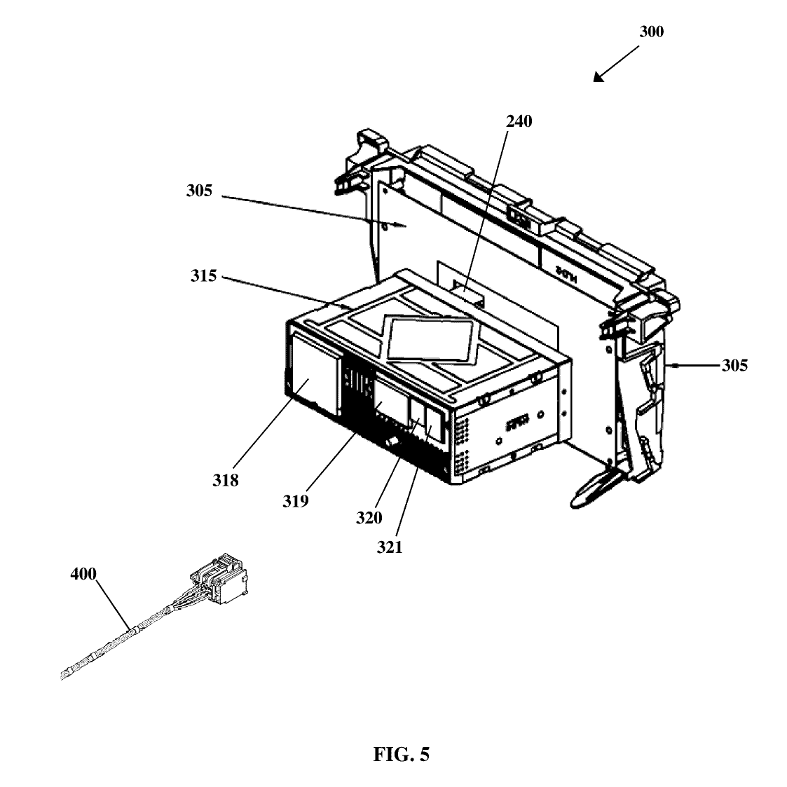

FIG. 5 is an illustration of one embodiment of a rear perspective view of the vehicle display system. FIG. 5 shows that the system 300 may be an aftermarket installed system and may comprise frame 305, connector plate 310, which may house display device 200, and universal display adaptor 315. FIG. 5 shows that the display device 200 and the universal display adaptor 315 are electrically coupled together via wire harness 240.

FIG. 5 shows that the universal display adaptor 315 may comprise vehicle connection ports 318, 319, 320, 321. The vehicle connection ports 318, 319, 320, 321 allow the universal display adaptor 315 to connect to almost every late model vehicle. Specifically, at least one of the vehicle connection ports 318, 319, 320, 321, which may be many more than four connection ports, may be configured to matingly couple with a vehicle original equipment manufacturer harness 400 (OEM harness 400). In various embodiments, the OEM Harness may be coupled to an adapter cable, which may also be coupled to universal display adapter 315.

In various embodiments the vehicle connection ports 318, 319, 320, 321 may enable audio, video, data, and power transmission and receiving. The vehicle connection ports 318, 319, 320, 321 may be male, female, serial ports, USB (regular, micro, or mini), SCSI, parallel ports, modular connectors, DCE, DTE, 4P4C (RJ9), 6P4C (RJ11), 8P8C (RJ45), jack, minijack, DIN, BNC, TOSLINK, XLR, TRS, DVI, SCART, co-axial, HDMI, DisplayPort, FireWire, i.LINK, 30 pin, 8 pin, lightening, 20 pin, 24 pin, 36 pin, DB-25, DE-9, TIA-574, MMJ, 10P10C, RJ50, and/or optical.

In a preferred embodiment, at least one vehicle connection port may be modular such that various types of vehicle connection ports may interface with the vehicle-specific OEM wire harness 400. This allows the universal display adaptor 315 to interface with virtually any type of vehicle, simply by replacing the one or more vehicle connection ports that is compatible with the vehicle's OEM wire harness 400, which is generally vehicle specific. Thus, the vehicle connection port, which would preferably would fit with the universal display adaptor 315, would include a specific pin wiring scheme compatible with a vehicle-specific wire harness.

The universal display adaptor 315 is preferably an interface unit or an audio-video box that is not vehicle specific and is used to transfer, convert, process, and forward signals (e.g., audio, radio, climate, data) and/or other types of communications from the universal display adaptor 315 to the vehicle, and vice versa, via the OEM harness 400. The OEM harness 400 is typically connected to the radio, climate, and other center dashboard/console controls. In order to make room for system 300 in the dashboard of the vehicle, it is typically necessary to remove a portion of the dashboard, the radio, climate controls, and/or climate vents. What is removed depends on the vehicle. For instance, in one embodiment, the air conditioner vents, control knobs, and buttons may be removed. The frame 305 and the display device 200 may be sized to fit a particular vehicle. Although there are hundreds of different vehicle makes and models the dashboard sizes and shapes are relatively limited, such that only a limited number of sizes of display devices 200 and sizes and shapes of frames 305 may be needed in order to fit all late model vehicles. To the extent that numerous types of frames might be needed to fit into any vehicle, this part is not an expensive part compared to the display device or the display adaptor. On the other hand, there are numerous types of radio harnesses that are used by the numerous types of vehicles. Typically, this would require numerous types of display adaptors to be manufactured. As a result, each type of the display adaptors are not made in large quantities. This, in turn, results in the display adaptors being much more expensive to manufacture than if only one type needed to be made. Accordingly, an important advantage of the universal display adaptor 315 is the ability to interface with the radio harness of almost any late model vehicle.

The universal display adaptor 315 may be available in one standard size, but may be any shape or size.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A vehicle display system, comprising:
a display device;
a frame;
a connector plate; and
a universal display adaptor;
wherein said display device comprises: a display screen, a housing, a rear casing, an electronic computing unit, and a wire harness;
wherein said connector plate comprises a connector plate opening;
wherein said rear casing comprises a rear casing opening;
wherein said wire harness comprises an adaptor connector;
wherein said wire harness 1) is coupled to said electronic computing unit, 2) passes through said connector plate opening and said rear casing opening, and 3) said adaptor connector couples to said universal display adaptor;
wherein said frame and said display device are mounted onto a front face of said connector plate;
wherein said universal display adaptor is mounted onto a back face of said connector plate; and
wherein said vehicle display system is configured to be installed into an interior of a vehicle.

2. The system of claim 1, wherein said vehicle display system is configured to be installed into a dashboard of said interior of a vehicle.

3. The system of claim 1, wherein said electronic computing unit communicates with one or more external electronic devices.

4. The system of claim 3, wherein said electronic computing unit is controlled by said one or more external electronic devices.

5. The system of claim 3, wherein said display screen mirrors a display of said one or more external electronic devices.

6. The system of claim 1, wherein said electronic computing unit comprises a navigation system.

7. The system of claim 1, wherein said universal display adaptor has a plurality of vehicle connection ports.

8. The system of claim 7, wherein said plurality of vehicle connection ports are modular and interchangeable to allow said vehicle display system to universally interconnect with substantially all late model vehicles.

9. The system of claim 7, wherein one or more of said plurality of vehicle connector ports couple with an OEM harness of said vehicle.

10. The system of claim 7, wherein there are four or more vehicle connection ports.

11. A universal vehicle display system, comprising:
a display device; and
a universal display adaptor;
wherein said display device comprises: a display screen, an electronic computing unit, and a wire harness;
wherein said wire harness comprises an adaptor connector;
wherein said wire harness is coupled to said electronic computing unit and said adaptor connector couples with said universal display adaptor;
wherein said vehicle display system is configured to be installed into an interior of a vehicle;
wherein said universal display adaptor has a plurality of vehicle connection ports;
wherein one or more of said plurality of vehicle connector ports are adapted to couple with an OEM harness of said vehicle; and
wherein said plurality of vehicle connection ports are modular and interchangeable to allow said vehicle display system to universally interconnect with substantially all late model vehicles.

12. The system of claim 11, wherein said vehicle display system is configured to be installed into a dashboard of said interior of a vehicle.

13. The system of claim 11, wherein said electronic computing unit communicates with one or more external electronic devices.

14. The system of claim 13, wherein said electronic computing unit is controlled by said one or more external electronic devices.

15. The system of claim 13, wherein said display screen mirrors a display of said one or more external electronic devices.

16. The system of claim 11, wherein said electronic computing unit comprises a navigation system.

17. The system of claim 11, wherein there are four or more vehicle connection ports.

18. A vehicle display system, comprising:
a display device;
a universal display adaptor;
wherein said display device comprises: a display screen, an electronic computing unit, and a wire harness;
wherein said wire harness comprises an adaptor connector;
wherein said wire harness is coupled to said electronic computing unit and said adaptor connector couples to said universal display adaptor;
wherein said vehicle display system is configured to be installed into a dashboard of a vehicle;
wherein said electronic computing unit communicates with and is controlled by one or more external electronic devices; and
wherein said display screen mirrors a display of said one or more external electronic devices.

19. The system of claim 1, wherein said electronic computing unit comprises a navigation system.

20. The system of claim 1, wherein said universal display adaptor has a plurality of vehicle connection ports;
wherein said plurality of vehicle connection ports are modular and interchangeable to allow said vehicle display system to universally interconnect with substantially all late model vehicles;
wherein one or more of said plurality of vehicle connector ports couple with an OEM harness of said vehicle.
